(19) United States
(12) Patent Application Publication
(10) Pub. No.: US 2025/0260231 A1
(43) Pub. Date: Aug. 14, 2025

(54) METHOD, COMPUTER PROGRAM AND COMPUTING UNIT FOR OPERATING AT LEAST TWO INDEPENDENT ENERGY STORAGE DEVICES IN AN ELECTRICAL SUB-GRID, AND ELECTRICAL SUB-GRID

(71) Applicant: Viessmann Holding International GmbH, Allendorf (DE)

(72) Inventors: Cornelius FÜTTERER, Gernrode (DE); Christian LANDAU, Edermünde-Besse (DE)

(73) Assignee: Viessmann Holding International GmbH, Allendorf (DE)

(21) Appl. No.: 19/051,135

(22) Filed: Feb. 11, 2025

(30) Foreign Application Priority Data
Feb. 14, 2024 (DE) 10 2024 104 143.9

(51) Int. Cl. H02J 3/32; H02J 13/00

(52) U.S. Cl. CPC H02J 3/32; H02J 13/00002

(57) ABSTRACT

A method is disclosed for operating a first and a second energy storage device, independent of the first, in an electrical sub-grid connected to a higher-level grid via a grid connection point. The sub-grid further includes at least one energy generating device, at least one energy consuming device and at least one measuring device at the grid connection point. The method comprises; determining a target power output or a target power consumption at the grid connection point as a first reference variable, determining a target power output or a target power consumption of the first energy storage device as a second reference variable, determining a first deviation from the first reference variable and a second deviation from the second reference variable, and adjusting a power output or a power consumption of the first energy storage device based on a weighting between the first deviation and the second deviation.

### CROSS-REFERENCE TO RELATED APPLICATIONS

The present application claims priority to DE 10 2024 104 143.9, filed Feb. 14, 2024, the entire contents of which are incorporated herein by reference.

### TECHNICAL FIELD

The present disclosure relates to a method for operating at least two independent energy storage devices in an electrical sub-grid, as well as a computing unit and a computer program for executing the method and an electrical sub-grid.

### BACKGROUND

Electrical sub-grids, such as a domestic grid, are usually connected to a higher-level distribution grid or transmission grid via a grid connection point. Such a sub-grid may comprise its own energy generation devices, such as a photovoltaic system, as well as energy storage devices and energy consuming devices. In order to use the electrical energy provided by the energy generation device as much as possible, the sub-grids are often configured to minimize the power flowing through the grid connection point to the higher-level distribution grid and, in the event of a surplus of energy, to store as much self-generated energy as possible in the energy storage devices. To achieve this, they can be configured to regulate active power at the grid connection point to zero, for example. If additional energy storage devices are to be integrated into the sub-grid in this case, a higher-level control (energy management system) or communication between the energy storage devices is necessary to avoid mutual interference, e.g. unwanted energy exchange between the storage devices. However, such a control/communication system is not always available, especially when energy storage devices from different manufacturers are used, so it is desirable to be able to operate independent energy storage devices in a common sub-grid without negative interactions occurring between them.

### SUMMARY

The disclosure is based on the object of coordinating the operation of at least two independent energy storage devices not communicating with each other in an electrical sub-grid in such a way that the energy storage devices do not negatively influence each other, in particular that they do not charge and/or discharge each other. This means, for example, that existing energy storage devices with grid connection point control can be expanded to include additional energy storage devices, e.g. from other manufacturers.

The object is solved by the features of the independent claims. Advantageous embodiments are provided in the dependent claims.

The method according to the disclosure is for operating at least a first and at least a second energy storage device, which is independent of the first, in an electrical sub-grid. A second independent energy storage device is to be understood as an energy storage device that is not located in an energy storage system of the first energy storage device and therefore cannot be readily controlled/regulated by its energy storage management (ESM) and cannot communicate with the first energy storage device. This may be the case, for example, if the second energy storage device comes from a different manufacturer than the first energy storage device. The terms “first” and “second” energy storage device are used here merely to distinguish one energy storage device from another and do not limit the number of energy storage devices in the electrical sub-grid to two.

In an example, the first and second energy storage devices may be battery storage devices for storing electrical energy, each comprising at least one inverter. The battery storage devices may be equipped with lithium-ion and/or lithium iron phosphate batteries, for example. The inverters of the first and second energy storage devices may each comprise an inverter module with power electronics components and a computing unit with a processor. The method may also be used to operate other independent components in the electrical sub-grid, such as additional independent energy generation units (e.g. photovoltaic systems).

In an example, the electrical sub-grid may be a domestic grid, for example a domestic grid with a power range (electrical power) of up to approx. 10 KW (e.g. for a single-family house) or up to approx. 100 KW (e.g. for an apartment building or a commercial property). Other types of sub-grids are also possible, such as a grid section of a distribution grid for supplying a property or a distribution grid for supplying a locality.

The electrical sub-grid is connected to a higher-level grid (e.g. distribution grid, island grid or transmission grid) via a grid connection point and includes, in addition to the energy storage devices, at least one energy generator unit for generating electrical energy, at least one energy consuming device and at least one measuring device for recording all energy flows in the electrical sub-grid at the grid connection point. The at least one energy generation unit may be a photovoltaic system (PV system). Other energy generation units, such as wind turbines, etc., are also possible. The at least one measuring device may, for example, be an energy meter that records the current flow at the grid connection point and determines the energy flows in the electrical sub-grid on this basis. There may be an energy meter for each of the two energy storage devices, i.e. the first and second energy storage devices may each have their own energy meter. Furthermore, the first energy storage device may comprise at least one current measuring device and at least one voltage measuring device to determine the power consumed or generated by the first energy storage device.

The method of operating the first and second energy storage devices in the sub-grid includes determining a target power output or target power consumption at the grid connection point of the sub-grid as first reference variable and a target power output or target power consumption of the first energy storage device as second reference variable. In other words, how much power is to be fed into the higher-level network or drawn from it is determined as a first reference variable for a control of the energy flows in the subnetwork. Likewise, a target value for the power consumption/output of the first energy storage device is determined as a second reference variable of the control.

According to an example, a value of zero can be determined for the target power consumed or generated at the grid connection point and the target power consumed or generated by the first energy storage device, i.e. the first and second reference variables can be set to a target power value of 0 W. In this way, both the power drawn from the grid connection point and the power of the first, system-own energy storage device can be minimized and initially only power can be drawn from or supplied to the second, independent energy storage device. This applies in particular if the target power consumption/output of the second energy storage device at the grid connection point is also 0 W.

The two reference variables can, for example, be stored in a computing unit of the electrical sub-grid and sent to a computing unit of the first energy storage device. In particular, the computing unit of the sub-grid may be the computing unit of the first energy storage device or a separate computing unit. The second energy storage device may comprise a separate computing unit which may control/regulate it independently of the first energy storage device. The computing units may each be signal-connected to the at least one energy meter and configured to receive measured values therefrom. In particular, the computing units of the first and second energy storage devices may each access their own energy meter.

After the first and second reference variables have been determined, a first deviation from the first reference variable and a second deviation from the second reference variable are determined and a power output or a power input of the first energy storage device is adjusted based on a weighting between the first deviation and the second deviation. According to an embodiment, the weighting may be, for example, at least one weighting factor FG. This may, e.g., take values between zero and one. In this case, e.g., the first deviation may be multiplied by the weighting factor FG and the second deviation multiplied by a difference of 1-FG in order to adjust the power consumed or generated by the first energy store.

To determine the first deviation from the first reference variable, the energy meter may, for example, measure the actual power output/input at the grid connection point and compare it with the target power output/input. The second deviation from the second reference variable may be determined accordingly by comparing the actual power consumed or generated by the first energy storage device with its target power output or input. The first and second deviations may be calculated for example in the computing unit of the subnetwork and/or in the computing unit of the first energy storage device.

According to an embodiment, the weighting between the first and second deviations may be dependent on an absolute value of the first deviation. For this purpose, the determined first deviation may be filtered over a plurality of values, e.g., by means of a mean value or a PT1 filter, an amount of the filtered value may be formed, and, for example, the weighting factor FG may be determined therefrom.

In an example, the weighting between the first and second deviations may be such that the power consumed or generated by the first energy storage device increases with increasing absolute value of the first deviation. For example, the first deviation is given a lower weighting if it only shows small values, and the second deviation is weighted correspondingly higher, whereas in the case of large deviations of the first deviation, the second deviation is weighted lower and the first deviation is weighted higher. In this way, when the power consumed or generated at the grid connection point is very low, for example when the second energy storage device is essentially supplying a required power to the sub-grid (e.g. by operating an energy-consuming device) or absorbing surplus power from it (e.g. by operating the PV system), the power consumed or generated by the first energy storage device is essentially regulated to the reference variable of 0 W. If the second energy storage device can no longer (fully) provide the power required in the sub-grid or can no longer (fully) consume the power fed into the sub-grid by an energy generating device, the absolute value of the first deviation increases and there is a continuous shift in the weighting from the second deviation to the first deviation, so that the first deviation is now corrected more strongly. This results in an increase in the power consumed or generated by the first energy storage device in order to minimize the amount of energy drawn from or fed into the grid if the second energy storage device is no longer able to provide (all of) the power required or absorb (all of) a power surplus. The behaviour described above may be adjusted in particular by means of a closed control loop.

According to an embodiment, the weighting between the first and second deviations may be such that a determined first deviation is maintained when power is consumed or generated by the first energy storage device. In other words, the weighting can be used to limit a control deviation from the second reference variable (second deviation) in such a way that a control deviation from the first reference variable (first deviation) is not completely eliminated/compensated by the first energy storage device. In other words, a minimal weighting of the control deviation from the second reference variable may be greater than zero. This may be adjusted, for example, by means of one or more amplification factors, with which the first and/or second deviation may be amplified/scaled. In this case, a power corresponding to the determined first deviation is fed into the higher-level grid (grid feed-in) or drawn from it (grid purchase), wherein the grid feed-in/purchase is significantly lower than the power consumed or generated by the first energy storage device. This can prevent the computing unit of the second energy storage device from recognizing energy stored in the first energy storage device as surplus power and using it to charge the second energy storage device. Likewise, in the opposite case, when the first energy storage device is consuming power (charging), the second energy storage device's computing unit may prevent the first energy storage device from being recognized as a consumer and also from being charged by the second energy storage device.

According to an example, the determined first deviation can be determined as a function of a measurement tolerance of the at least one measuring device at the grid connection point. If a grid feed-in or a grid purchase, e.g. from the energy meter of the first energy storage device at the grid connection point, can be determined very accurately, the determined first deviation when discharging or charging the first energy storage device may be adjusted to be correspondingly small, since in this case there is no risk, for example, of misdetection of the power flow direction at the grid connection point, which may supply the first energy storage device incorrectly as an energy generating device or energy consuming device, which in turn may cause the second energy storage device to charge or discharge the first energy storage device undesirably.

According to one embodiment, the weighted first and second deviations may be supplied to a controller for adjusting the power consumed or generated at the grid connection point and the power consumed or generated by the first energy storage device. For example, a difference between the weighted first and second deviations may be supplied to the controller, which may then determine, e.g., a control variable for the inverter of the first energy storage device. In an example, the controller may be a PI controller. The controller may, for example, be integrated in the computing unit of the subnetwork and/or, for example, in the computing unit of the first energy storage device.

A computing unit according to the disclosure is configured, in particular in terms of program technology, to carry out the method according to the disclosure described above. The computing unit may be a computing unit of an electrical sub-grid, which may, for example, be included in a computing unit of a first energy storage device or may be a separate computing unit.

The implementation of a method according to the disclosure in the form of a computer program or computer program product with program code for carrying out all the steps of the method is also advantageous because this incurs particularly low costs, especially if a computing unit is used for other tasks and is therefore already available. Suitable data carriers for providing the computer program can be, as non-limiting examples, magnetic, optical, and electrical storage devices, such as hard disks, flash memory, EEPROMs, DVDs, etc. It is also possible to download a program via computer networks (Internet, intranet, etc.).

The present disclosure allows for coordinated charging and discharging of the first and second energy storage devices by controlling both the power consumed or generated at the grid connection point and the power consumed or generated by the first energy storage device, and by weighting the two control variables (first and second deviations). This means that the second energy storage device may be fully discharged/charged before the first energy storage device is used. In addition, the weighting of the first and second deviations and the resulting low power consumed or generated from the higher-level grid ensures that no power flows into or out of the second energy storage device when the first energy storage device is consuming or generating power.

### BRIEF DESCRIPTION OF THE FIGURES

FIG. 1 schematically shows an electrical sub-grid according to a design example of the disclosure, which comprises a first energy storage device and a second, independent energy storage device.

FIG. 2 schematically shows an example of a function block for controlling the first energy storage device in the sub-grid shown in FIG. 1.

FIGS. 3a and 3b show, respectively, an absolute and a relative course of power consumed or generated at the grid connection point as a function of the total power consumed or generated in the sub-grid shown in FIG. 1 when the first energy storage device is active.

FIGS. 4a to 4c show energy flows and states of charge of the two energy storage devices in the sub-grid shown in FIG. 1 when the method according to the disclosure is not applied.

FIGS. 5a to 5c show energy flows and states of charge of the two energy storage devices in the sub-grid shown in FIG. 1 when a design example of the method according to the disclosure is applied.

### DESCRIPTION

In the following, design examples of the present disclosure are described in detail on the basis of exemplarily figures. The features of the design examples can be combined in whole or in part and the present disclosure is not limited to the described design examples. In the figures, identical or comparable elements are provided with the same reference signs, so that a repeated description of the elements is dispensed with, unless this is necessary.

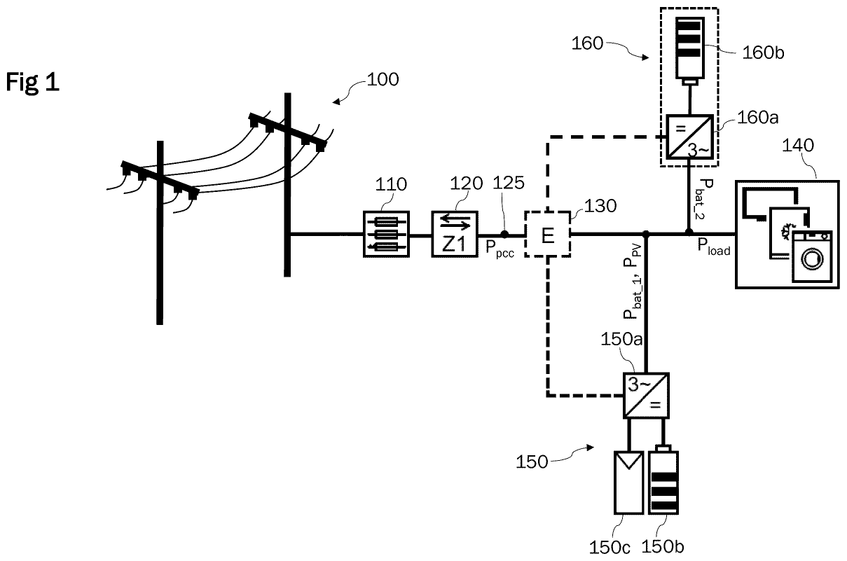

FIG. 1 schematically shows an electrical sub-grid according to a design example of the disclosure. The electrical sub-grid shown is a domestic grid that is connected via a grid connection point 125 to a higher-level grid 100, which may, for example, be a distribution grid, an isolated grid, or a transmission grid. A grid connection box 110 and a utility meter 120 belonging to the grid operator/energy supplier are located on the side of the higher-level grid 100 before the grid connection point 125. An energy meter 130 is arranged on the grid connection point 125 on the side of the domestic grid, which detects the current flow at the grid connection point 125 and determines the energy flows in the electrical domestic grid from this. Electrical power P_{pcc} may be exchanged between the domestic grid and the higher-level grid 100 via the grid connection point 125. However, in order to use the energy generated in the domestic grid to a large extent, the energy flows in this grid are preferably controlled to an electrical power P_{pcc, set}=0 W (first reference variable).

In the present case, the domestic grid includes a first energy storage device 150 and a photovoltaic system (PV system, not shown), the energy generated by which is fed into the domestic grid by means of corresponding photovoltaic connections 150c to the first energy storage device 150. The depicted first energy storage device 150 also has a first battery 150b and a first inverter 150a. The first energy storage device 150 may also include several first batteries 150b. The first inverter 150a may comprise an inverter module with power electronics components and a computing unit with a processor (not shown), which may be used to control the power consumed or generated by the first energy storage device. For this purpose, the computing unit of the first energy storage device 150 may receive a power measurement from the energy meter 130 at the grid connection point 125 (indicated by the dashed line between the energy meter 130 and the first inverter 150a) and determine from this a power output/consumption to be adjusted by means of the first inverter 150a. The first inverter 150a may be used to supply power to or consume power from P_{bat_1} the first battery 150b, as well as to feed power from the PV system P_{PV}. Furthermore, the first energy storage device 150 may comprise at least one current measuring device and at least one voltage measuring device (not shown) to determine the power consumed or generated by the first energy storage device 150.

The depicted domestic grid also includes several energy-consuming devices 140, wherein exemplarily and without further specification a television, a refrigerator and a washing machine are shown, which draw a power P_{load} from the domestic grid during operation.

Furthermore, the domestic grid comprises a second energy storage device 160, which is connected to the domestic grid independently of the first energy storage device 150 and in parallel with it. In the present case, the second energy storage device 160 includes a second battery 160b and a second inverter 160a. This may also comprise an inverter module with power electronics components and a computing unit with a processor (not shown). The latter may also receive a power measurement from the energy meter 130 at the grid connection point 125 (indicated by the dashed line between the energy meter 130 and the second inverter 160a) and determine a power consumed or generated P_{bat_2} via the second inverter 160a, independently of the first energy storage device 150. It is also possible for the second energy storage device 160 to measure the power at the grid connection point 125 by means of its own second energy meter (not shown). However, the present use of a common energy meter 130 for both energy storage devices 150, 160 offers the advantage that these measured power values are received by the same measuring device 130, whereby a tolerance between input variables of the control of the two energy storage devices 150, 160 can be minimized. Instead of a second independent energy storage device 160, a second independent PV system may also be integrated into the domestic grid, which may be operated in the same way as the second independent energy storage device 160 in view of power output into the domestic grid.

To prevent the first and second batteries 150b, 160b from charging and discharging each other as a result of the power at grid connection point 125 being controlled independently of the first reference variable P_{PCC, set}=0 W, the control system for the first energy storage device 150 includes a second reference variable P_{bat_1, set}, which is used to set a target power output/power consumed by the first energy storage device 150 to a value of P_{bat_1, set}=0 W. For the coordinated control of both controlled variables, a weighting is performed between a first deviation ΔP_{PCC} from the first reference variable P_{PCC, set} and a second deviation ΔP_{bat_1} from the second reference variable P_{bat_1}, set. In an example, the weighting may depend on an absolute value of the first deviation, so that if the first deviation ΔP_{PCC} is small, the second deviation ΔP__{bat_1} is prioritized and adjusted. With an increasing absolute value of the first deviation ΔP_{PCC}, the weighting/prioritization shifts in the direction of the first reference variable P_{PCC, set}, so that a larger second deviation ΔP_{bat_1} is now tolerated and the first deviation ΔP_{PCC} is reduced in this way. By doing so, the second battery 160b of the second energy storage device 160 may be discharged/charged first to avoid a grid purchase/grid feed-in, since the first deviation ΔP_{PCC} can be largely compensated for during this process. The first energy storage device 150 only becomes active if the power/charging capacity of the second battery is no longer sufficient.

If a load P_{load} is activated in the domestic grid, e.g. by switching on the washing machine, both energy storage devices are initially activated at the time of activation, as a high first deviation from the first reference variable occurs at this moment. However, due to the weighting between the first and second deviation ΔP_{PCC}, ΔP_{bat_1} in the control of the first energy storage device 150, the power output of the latter is reduced very quickly, so that after a transient oscillation, the load of the washing machine is only compensated by a power output of the second energy storage device 160 (discharging the second battery 160b).

If the second battery 160b is discharged or the discharge power of the second battery 160b is insufficient for load compensation, a control deviation ΔP_{PCC}>0 W (first deviation ΔP_{PCC} from the first reference variable P_{PCC, set}) occurs again, which can be detected by the computing unit of the first inverter 150a by means of the energy meter 130. Based on the now stronger weighting of the first deviation ΔP_{PCC}, the inverter may then adjust a second deviation ΔP__{bat_1} from the second reference variable P_{bat_1, set}=0 W in order to reduce the control deviation at the grid connection point 125.

To prevent the computing unit of the second energy storage device 160 from recognizing the power output of the first energy storage device 150 as surplus power and using it to charge the second energy storage device, the first deviation ΔP_{PCC} is not fully corrected, but a certain first deviation is maintained, which ensures that, simultaneously with the power output of the first energy storage device 150 a corresponding small amount of power is fed into the higher-level grid 100.

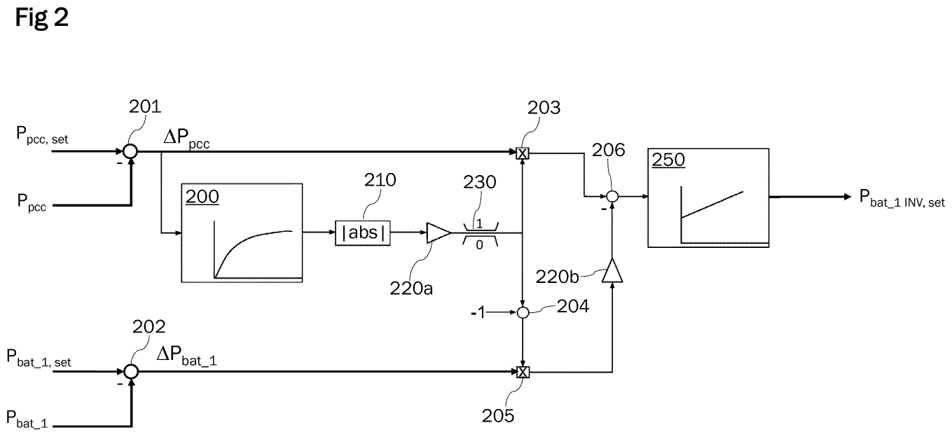

In this context, FIG. 2 schematically shows an example of a function block for controlling the first energy storage device 150 in the domestic grid shown in FIG. 1.

The function block has as input variables the first and second reference variables P_{PCC, set}, P_{bat_1, set}, an actual power P_{pcc} consumed or generated at grid connection point 125 and an actual power P_{bat_1} consumed or generated by the first energy storage device 150.

In an upper path of the function block, the first deviation ΔP_{pcc} from the first reference variable P_{PCC}, set at the grid connection point 125, is determined at a node 201 and supplied to a filter 200, which filters the determined first deviation ΔP_{pcc} over several measurements. To determine a weighting factor FG, an absolute value is formed from an output variable of the filter 200 in a calculation element 210, this is multiplied by a first amplification factor 220a and limited by a limiting element 230 to values between 0 and 1. In particular, the first amplification factor may be equal to or less than 0.02. The first deviation ΔP_{pcc} is then multiplied by the weighting factor FG determined in this way at a node 203.

In a lower path of the function block, the second deviation ΔP__{bat_1} from the second reference variable P_{bat_1, set} of the second energy storage device 160 is determined accordingly at a node 202. In order to carry out a weighting between the first deviation ΔP_{pcc} and the second deviation ΔP__{bat_1}, the second deviation is subsequently multiplied by a difference (FG-1) formed at node 204.

It is clear that with a small first deviation ΔP_{pcc}, the weighting factor FG also takes on a small value, so that the second deviation ΔP__{bat_1} is weighted more heavily. This may be the case in particular when the power required/provided in the domestic grid is supplied/consumed by the second energy storage device 160. In this case, the second deviation ΔP__{bat_1} can be corrected and the target power output/consumption P_{bat_1, set}=0 W of the first energy storage device 150 can be adjusted.

When the first deviation ΔP_{pcc} increases due to the increasing discharge or charge of the second energy storage device 160, the weighting factor FG also increases, so that the first deviation ΔP_{pcc} is now weighted more heavily, which reduces the control deviation at the grid connection point 125 (first deviation ΔP_{pcc}), while the control deviation of the first energy storage device 150 (second deviation ΔP_{bat_1}) increases. In this way, the first energy storage device 150 takes over when the power/charging capacity of the second energy storage device 160 decreases.

In the present case, the weighted second deviation is multiplied by a second amplification factor 220b and subtracted from the first weighted deviation at a node 206. The second amplification factor 220b may, for example, be equal to or less than 0.2.

According to the present design example, the difference formed at node 206 between the first and second weighted deviations is provided to a controller 250, which determines therefrom a control variable PINV, set, for example, for an inverter at the grid connection point (not illustrated) and/or a control variable P_{bat_1_INV, set} for an inverter 150a of the first energy storage device 150, in order to adjust the power consumed or generated at the grid connection point 125 as well as the power consumed or generated by the first energy storage device 150. Depending on the sign of the gain factors 220a, 220b, a sum of the first and second weighted deviations may also be formed at the node 206.

In particular, the first and second amplification factors 220a, 220b may be used to adjust the determined first deviation, which prevents the control deviation at the grid connection point 125 from being fully corrected when charging and discharging the first energy storage device 150. As described above, the low power that is thereby adjusted via the grid connection point 125 prevents the computing unit of the second energy storage device 160 from recognizing energy stored in the first energy storage device 150 as surplus power and using it to charge the second energy storage device 160, or the first energy storage device 150 from being recognized by the computing unit of the second energy storage device 160 is detected as a consumer and is also charged by the second energy storage device 160.

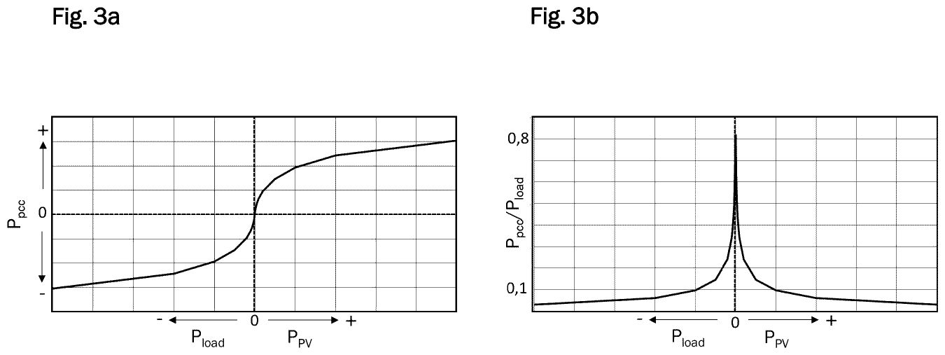

The course of the determined first deviation as a function of the total power consumed or generated in the domestic grid is described below in conjunction with FIGS. 3a and 3b. The power consumed by an energy-consuming device 140 in the domestic grid, P_{load}, and the power generated by the PV system and fed into the domestic grid, P_{PV}, each represent a sum of the power consumed or generated by the first energy storage device 160 and the power consumed or generated at the grid connection point 125.

FIG. 3a shows the absolute values of the power consumed or generated P_{pcc} at the grid connection point 125, and FIG. 3b shows the ratio of the power consumed or generated P_{pcc} at the grid connection point 125 to the total power consumed or generated P_{load}, P_{PV} in the domestic grid. The courses of power consumed or generated P_{pcc} at the grid connection point 125 shown are based on the weighting of the first and second deviations ΔP_{pcc}, ΔP_{bat_1} from the respective reference variable P_{PCC}, P_{bat_1} as described above. Here, the first amplification factor 220a was adjusted to a value of 0.02 and the second amplification factor 220b to a value of 0.2.

In a first quadrant of the diagram shown in FIG. 3a, a curve for a grid feed-in (P_{pcc}>0) is plotted as a function of a power feed-in by an energy generator unit (P_{PV}>0), when the latter is also used to charge the first energy storage device 150. In the third quadrant of this diagram, a curve is plotted for a grid supply (P_{pcc}<0) depending on a power output to an energy consuming device (P_{load}<0), when the latter is also provided by discharging the first energy storage device 150. This curve corresponds to a reflection of the curve plotted in the first quadrant at the origin of the diagram. The steep course of the curves in a range near the origin reveals that at low power input or low power output to an energy consuming device, the power P_{pcc} via the grid connection point changes significantly. In particular, in this range, e.g. a power output to an end user is essentially covered by the grid supply, as can be seen in particular from FIG. 3b, which illustrates the share of the grid supply P_{pec} in the power output P_{load}. However, due to the steep drop in the curves in the range of the origin, this unfavorable range is not very significant, e.g. for conventional power consumption of energy consuming devices, and the required power can be provided mainly by the first energy storage device 150. Thus, in this case, the advantages of coordinated charging and discharging of the first and second energy storage devices 150, 160 outweigh the disadvantages of a slightly higher grid supply. By varying the first and second amplification factors 220a, 220b, the maximum and minimum values of the curves and their rise and fall around the origin can be changed. In this way, measurement tolerances of the at least one energy meter 130 at the grid connection point 125 can be taken into account.

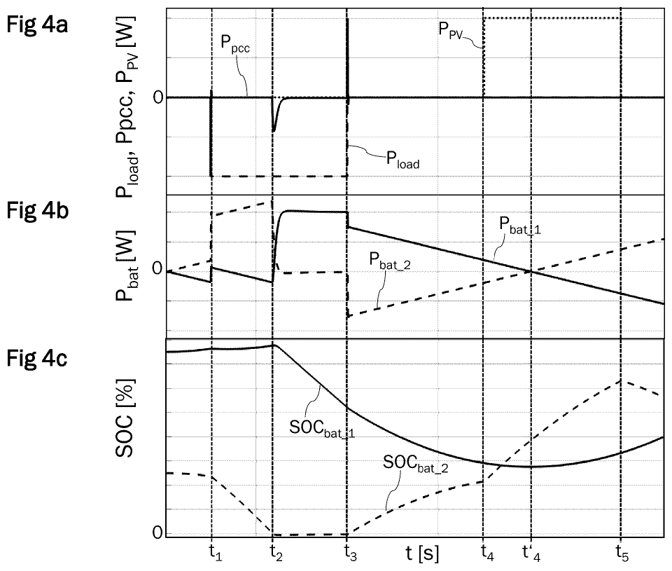

FIGS. 4a to 4c show the energy flows and states of charge of the energy storage devices 150, 160 in the domestic grid shown in FIG. 1 when the method according to the disclosure is not used. In this case, the power consumed or generated by each of the two energy storage devices 150, 160 at the grid connection point 125 is regulated to 0 W, in order to use the energy generated by the PV system preferably in the domestic grid.

FIG. 4a shows a power output P_{load} to an energy-consuming device 140, a power consumed or generated P_{pec} via the grid connection point 125 and a power input P_{PV} by the PV system.

FIG. 4b shows a power consumed or generated by the first energy storage device 150 or its first battery 150b, and a power consumed or generated by the second energy storage device 160 or its second battery 160b.

FIG. 4c shows a state of charge SOC_{bat_1} of the first battery 150b and a state of charge SOC_{bat_2} of the second battery 160b. The variables shown in the individual figures are plotted over a time t.

At the beginning of the recording at time t=0, the state of charge SOC_{bat_2} of the second battery 160b is higher than the state of charge SOC_{bat} of the first battery 150b (see FIG. 4c). At this time, the power output P_{Load} to an energy consuming device is 140, the power consumed or generated P_{pcc} via the grid connection point 125 and the power P_{PV} fed in by the PV system is 0 W. However, since each of the two energy storage devices 150, 160 independently tries to achieve the control target of P_{pc}C=0 W at the grid connection point 125, a certain exchange of energy from the second energy storage device 160 to the first energy storage device 150 already takes place from this time on.

At a time t₁, an energy consuming device 140 is switched on, which draws a constant power P_{load} from the domestic grid until a time t₃. When the energy consuming device 140 is switched on, there is a peak power consumption P_{pec} from the higher-level grid 100 in the amount of the power consumed by the energy consuming device 140, whereupon the second energy storage device 160 begins to supply power P_{bat_2} to the domestic grid in order to provide the power for the operation of the energy consuming device 140. It can be seen that the power output P_{bat_2} in a period between t₁ and t₂ is higher than the power consumption P_{load} of the energy consuming device 140, since in this period, additional power P_{bat_2} of the second battery 160b is used to charge the first battery 150b.

At time t₂, the first battery 150b is discharged, which also results in a power consumption P_{pcc} from the higher-level grid 100, but this has a lower amplitude than the peak when the energy consuming device 140 is switched on. Thereupon, a power P_{bat_1} is delivered from the first battery 150b to the domestic grid in order to regulate the power at the grid connection point 125. The delivered power P_{bat_1} remains constant in the period from t₂ to t₃ and corresponds in magnitude to the power P_{load} consumed by the energy consuming device 140.

At time t₃, the energy consuming device 140 is switched off, causing a peak-shaped power output P_{pcc} at the grid connection point, which in turn results in a step-shaped power consumption P_{bat_2} of the second battery 160b. Since no other energy consuming device 140 is now consuming power, power P_{bat_1} flows continuously from the first battery 150b into the second battery 160b until a time t₄ and the state of charge SOC_{bat_1} of the first battery 150b decreases. This does not change even when the PV system is switched on at a time t₄. The latter only causes the second battery 160b to be charged faster, so that its state of charge SOC_{bat_2} rises more steeply. The first battery 150b is also recharged using the power output P_{PV} of the PV system. At time t₄, the energy flows reverse, and power P_{bat_2} is supplied from the second battery 160a to the first battery 150b, causing its state of charge SOC_{bat_1} to rise slightly again. Finally, at a time t₅, the PV system is switched off again, so that the state of charge SOC_{bat_2} of the second battery 160b now drops again, while the state of charge SOC_{bat_1} of the first battery 150b continues to rise.

It becomes clear that the parallel control of the two energy storage devices 150, 160 to a common control target of P_{pcc, set}=0 W at the grid connection point 125 leads to an undesirable energy exchange between the two energy storage devices 150, 160.

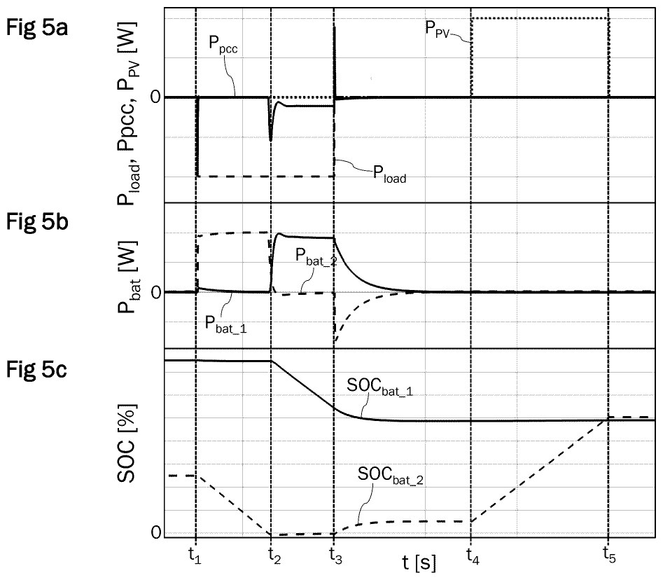

In contrast, FIGS. 5a to 5c show the energy flows and states of charge of the energy storage devices 150, 160 in the domestic grid shown in FIG. 1 when a design example of the method according to the disclosure is used.

The variables represented in these figures are identical to those in FIGS. 4a to 4c. However, the charging and discharging of the two energy storage devices 150, 160 is now coordinated such that initially only the second energy storage device 160 is pursuing the control target of P_{pec}=0 W (first reference variable) at the grid connection point 125 and a target power output/consumed or generated by the first energy storage device 150 is set to P_{bat_1, set}=0 W (second reference variable). This ensures that at the beginning of the recording, in the period from t=0 to t₁, there is no undesirable energy exchange between the two energy storage devices 150, 160.

At time t₁, an energy consuming device 140 is switched on, which draws a constant power P_{load} from the domestic grid until a time t₃. When the energy consuming device 140 is switched on, there is a peak power consumption P_{pec} from the higher-level grid 100 in the amount of the power consumed by the energy consuming device 140, whereupon the second energy storage device 160 begins to supply power to the domestic grid in order to provide the power for the operation of the energy consuming device 140. In the present case, the power P_{bat_2} supplied by the second energy storage device 160 corresponds to the power consumption P_{load} of the energy consuming device 140, since no additional power P_{bat_2} of the second battery 160b is used to charge the first battery 150b.

At time t₂, the second battery 160b is also discharged here, which again results in a power consumption P_{pcc} from the higher-level grid 100, but this time it has a lower amplitude than the peak when the energy-consuming device 140 is switched on. This is largely compensated by a power output P_{bat_1} of the first energy storage device 150, wherein during the discharge of the first battery 150b a small amount of power continues to flow through the grid connection point 125, which can prevent an undesirable charging of the second battery 160b. In particular, adjusting the small grid supply P_{pcc}, compared to the power output P_{bat_1} of the first battery 150b, prevents the computing unit of the second inverter 160a in the second energy storage device 160 from incorrectly recognizing the energy stored in the first battery 150b as surplus power and using it to charge the second battery 160b.

The power P_{pec} drawn from the grid connection point 125 and the power P_{bat_1} supplied by the first battery 150b remain largely constant in the period from t₂ to t₃ and their sum corresponds in amount to the power P_{load} consumed by the energy consuming device 140.

At time t₃, the energy consuming device 140 is switched off, causing a peak-shaped power output P_{pec} at the grid connection point 125, which in turn causes a step-shaped power consumption P_{bat_2} of the second battery 160b. Due to the filter 200 described in FIG. 2, by means of which the weighting factor FG for weighting the first and second deviations from the corresponding reference variables is formed, the reduction of the power output P_{bat_1} to the target value P_{bat_1}, set=0 W in the present example, is delayed, whereby the second battery 160b is slightly charged with energy from the first battery 150b. However, compared to the behaviour described in FIGS. 4a to 4c, this energy exchange is negligible and may be further reduced by changing the filter parameters of filter 200.

At time t₄, the PV system is also activated here, which then continuously charges only the second battery 160b by means of the power input P_{PV} until it is switched off at time t₅, since the target power output/power consumed of the first energy storage device 150 is P_{bat_1, set}=0 W and no control deviation is present at the grid connection point 125. This is visible in the increasing state of charge SOC_{bat_2} of the second battery 160b and the constant state of charge SOC_{bat_1} of the first battery 150b during this period. After the PV system is switched off, the state of charge of both batteries 150b, 160b remains constant due to the specified first and second reference variables (P_{pcc, set}=0 W, P_{bat_1, set}=0 W).

From the behaviour of the energy flows in the domestic grid, as described in FIGS. 4a to 5c, with and without the use of a design example of the method according to the disclosure, it is clear that the latter allows the charging and discharging of two independent energy storage devices to be coordinated, thereby preventing an unwanted exchange of energy between the two energy storage devices.

What is claimed is:

1. A method for operating at least one first energy storage device and at least one second energy storage device, which is the second energy storage device being independent of the first energy storage device, in an electrical sub-grid connected to a higher-level grid via a grid connection point wherein the electrical sub-grid includes at least one energy generating device, at least one energy consuming device and at least one measuring device at the grid connection point, the method comprising:
determining a target power output or a target power consumption at the grid connection point as a first reference variable;
determining a target power output or a target power consumption of the first energy storage device as a second reference variable;
determining a first deviation from the first reference variable and a second deviation from the second reference variable; and
adjusting a power output or a power consumption of the first energy storage device based on a weighting between the first deviation and the second deviation.

2. The method according to claim 1, wherein a value of zero is determined for the target power output or respectively the power consumption at the grid connection point and the target power output or respectively the target power consumption of the first energy storage device.

3. The method according to claim 1, wherein the weighting between the first and the second deviation is dependent on an absolute value of the first deviation.

4. The method according to claim 1, wherein the weighting between the first and second deviations is such that the power output or respectively the power consumption of the first energy storage device increases with increasing absolute value of the first deviation.

5. The method according to claim 1, wherein the weighting between the first and second deviations is such that a certain first deviation is maintained when power is consumed or generated by the first energy storage device.

6. The method according to claim 5, wherein the determined first deviation is determined as a function of a measurement tolerance of the at least one measuring device at the grid connection point.

7. The method according to claim 1, wherein the weighted first and weighted second deviations are supplied to a controller for adjusting the power consumed or generated by the first energy storage device and the power consumed or generated at the grid connection point.

8. The method according to claim 1, wherein the weighting between the first and the second deviation is carried out by means of at least one weighting factor.

9. A computing unit comprising a processor configured to carry out the method according to claim 1.

10. An electrical sub-grid connected to a higher-level grid via a grid connection point, having at least the first energy storage device and at least the second energy storage device independent of the first energy storage device, as well as at least one energy generating device, at least one energy consuming device, at least one measuring device at the grid connection point and a computing unit according to claim 9.

11. A computer program comprising instructions that, executed by a computer, cause the computer to carry out the method according to claim 1.

12. A computer-readable storage medium on which the computer program according to claim 11 is stored.
